(19) United States
(12) Patent Application Publication
(10) Pub. No.: US 2002/0186671 A1
(43) Pub. Date: Dec. 12, 2002

(54) Unmanned contract processing system

(75) Inventors: Kunihiro Nomura, Nagoya-shi (JP); Hitoshi Maekawa, Owariasahi-shi (JP); Takeshi Miura, Nagoya-shi (JP)

Correspondence Address: McDermott, Will & Emery, 600, 13th Street, N.W., Washington, DC, 20005-3096, US

(73) Assignee: Hitachi, Ltd.

(21) Appl. No.: 10/166,394

(22) Filed: Jun. 11, 2002

(30) Foreign Application Priority Data
Jun. 12, 2001 (JP) 2001-176555(P)

(51) Int. Cl. H04Q 7/00; H04L 12/28

(52) U.S. Cl. 370/328; 370/338; 370/352; 370/401; 370/389; 455/418

(57) ABSTRACT

An unmanned contract system is constructed by connecting a contract processing apparatus, which is manipulated by a financial institute for processing contracts, with a contract terminal, which is manipulated by each user, via a communication line. The contract processing apparatus obtains required information for a contract from each user's cellular phone, prior to the user's operations at the contract terminal and performs a preliminary examination. The result of the preliminary examination is mapped to an MAC address of the user's cellular phone obtained as identification information and is kept in the contract processing apparatus. The contract terminal fetches the MAC address from the user's cellular phone and transmits the MAC address to the contract processing apparatus. The user is not required to write down any identification information but can utilize the result of the preliminary examination. This arrangement ensures quick conclusion of the contract.

### BACKGROUND OF THE INVENTION

1. Field of the Invention

The present invention relates to an unmanned contract processing system that is capable of transmitting part of required information for a contract, prior to a user's operations at a contract terminal.

2.Description of the Related Art

Unmanned contract processing systems have become widely used in consumer credit business. The unmanned contract processing system includes a contract terminal and a contract processing apparatus, which are connected to each other via a communication line, such as a public telephone line. Each user generally operates the contract terminal located in an unmanned branch shop for a contract. Information input through the operation is transmitted to the contract processing apparatus manipulated by the operator of the financial institute. The operator of the financial institute checks the entry of a contract document, authenticates the user, and carries out the credit check of the user, based on the transmitted information.

One proposed method to shorten the waiting time of the user during the processing of the contract causes part of information required for the contract to be transmitted in advance to the contract processing apparatus. This enables the credit check of the user in advance (hereinafter referred to as the ‘preliminary examination’ or ‘pre-examination’). In the system according to this proposed method, when the user applies a financial institute for a loan via the Internet, by facsimile, by telephone, or by post, the financial institute sends back an application number to the user. The user inputs the application number at the contract terminal. This arrangement enables the contract to be quickly processed by utilizing the result of the preliminary examination.

In this system, the user should write down or otherwise memorize the application number given by the financial institute. This reduces the convenience of the system. When the user forgets the application number, the result of the preliminary examination can not be used for the further processing. The user should then wait for a long time to conclusion of the contract, like the regular processing for the contract. The waiting time is inconvenience for the user and lowers the capacity operating rate of the contract terminal in the financial institute.

Such problem is not limited in the contracts in the financial institutes but is common to any unmanned contract processing systems for automatically processing various contracts, such as applications for purchase of items and various services.

### SUMMARY OF THE INVENTION

The object of the present invention is thus to enhance the convenience and the capacity operating rate of an unmanned contract processing system that is capable of transmitting part of information required for a contract prior to a user's operation at a contract terminal.

At least part of the above and the other related objects is actualized by an unmanned contract processing system in which a contract processing apparatus and a contract terminal are connected to each other via a communication line. The respective constituents of the system have arrangements discussed below. In the specification hereof, the term ‘contract processing apparatus’ includes both an apparatus that is directly or indirectly connected to the contract terminal and a ‘host computer’ that receives input of preliminary information from a cellular phone and carries out a required series of processing.

The contract processing apparatus processes an application for a contract and includes a preliminary information input module and a preliminary information storage module. The preliminary information input module receives from a user at least part of information required for the contract as preliminary information, prior to the user's operation at a contract terminal. The preliminary information may be input into the contract processing apparatus directly or via the communication line. The preliminary information storage module stores a mapping to map the preliminary information to identification information.

The contract terminal is manipulated by the user to implement the operation required for the application for the contract, and includes a identification information input module and a contract execution module. The identification information input module receives the identification information from a information-providing medium, in which the identification information is stored. The contract execution module transmits the identification information to the contract processing apparatus and receives required information to execute processing of the application for the contract.

In the system of the present invention, the contract terminal and the contract processing apparatus obtain the identification information via the information-providing medium and thus readily and definitely specify the preliminary information. This arrangement desirably makes the user free from the load of writing down or otherwise memorizing the identification information and thereby enhances the convenience of the unmanned contract processing system.

In the system of the present invention, a diversity of methods may be applied for acquisition of the identification information from the information-providing medium. For example, short distance communication of the contract terminal with the information-providing medium may be used for the acquisition of the identification information. The short distance communication represents communication having a communicable range limited in the vicinity of the terminal, and includes communication utilizing infrared rays and communication utilizing feeble radio waves. One example of the latter communication utilizes Bluetooth (trademark). When the short distance communication is used for the acquisition of the identification information, the information-providing medium should have the function required for such communication. For example, the information-providing medium may be a cellular phone or another PDA (personal digital assistant) having the function of short distance communication.

Acquisition of the identification information from the information-providing medium is not restricted to short distance communication, but may be implemented by magnetic means, electrical means, or optical means according to the type of the information-providing medium. For example, in the case where a magnetic card is applied for the information-providing medium, the identification information is read by magnetic means. In the case where a cellular phone or another PDA is applied for the information-providing medium, the information-providing medium is connected to the contract terminal via a cable and the identification information is read by electrical means. In the case where a cellular phone or another equivalent device having a display is applied for the information-providing medium, the identification information on the display is read by optical means.

In the system of the present invention, the processing executed by the contract terminal may include acquisition of authentication information for authenticating the user. In this case, it is desirable that the authentication information partly overlaps the preliminary information. This arrangement ensures accurate identification of the person who currently operates the contract terminal based on the preliminary information, and effectively prevents unfair contracts based on false preliminary information and illegal contracts with unauthorized or found information-providing media.

In the system of the present invention, when the information-providing medium, such as the cellular phone, has the function of communication with the contract processing apparatus, the contract processing may notify the information-providing medium of the identification information. This arrangement enables the identification information to be definitely stored into the information-providing medium. Such notification may be carried out together with transmission of the preliminary information or at another timing.

The information-providing medium specified as the destination of notification of the identification information may be different from the input source of the preliminary information. In one preferable example, a general purpose computer having excellent operatability is used to input the preliminary information, whereas a portable terminal is used for notification of the identification information. This further enhances the convenience of the system.

The contract processing apparatus may notify the user of a ready state for the contract based on the preliminary information. The notification may be implemented through an operation of the contract processing apparatus by the operator. The contract processing apparatus may retrieve a database in which the ready state for the contract is registered and automatically transmit the notice to the user. Such notification desirably prevents the user from going to a branch shop where the contract terminal is located, while the processing is not in the ready state for the contract.

In the system of the present invention, the identification information may be specified in various ways. In one arrangement, information set by the contract processing apparatus, such as an application number, may be used as the identification information. In such cases, the contract processing apparatus notifies the user of the identification information, prior to the user's operation at the contract terminal.

In another arrangement, information intrinsic to the user stored in the information-providing medium possessed by the user may be used as the identification information. One example of such information is a number recorded in a magnetic card like an ATM card or a credit card. In such cases, the identification information is transmitted together with the preliminary information to the contract processing apparatus, prior to the user's operation at the contract terminal.

In still another arrangement, information intrinsic to the information-providing medium utilized for the communication with the contract terminal may be used as the identification information. One example of such information is address information used for communication. Such information is consequently transmitted on establishment of communication of the contract terminal with the information-providing medium, and is thus readily fetched from the information-providing medium.

The present invention is also directed to a settlement terminal or a transaction system. The transaction system executes a transaction process with regard to at least one of an application for purchase of an item and an application for a contract, and includes a settlement terminal, a first apparatus, and a second apparatus. The first apparatus is manipulated by a user. The second apparatus is involved in the transaction process, is communicable with the settlement terminal and the first apparatus, and receives from the first terminal at least part of information required for the transaction process. The second apparatus transmits, in response to the input of the at least part of the required information, identification information for identifying the input information. The settlement terminal communicates with the first apparatus to receive the identification information and execute the transaction process.

In the transaction system, when it is confirmed that a certain transaction utilizing the identification information is acceptable, a menu option may be displayed at the settlement terminal to allow the user to select the certain transaction. The information transmitted from the first apparatus to the second apparatus may include information representing a physical characteristic for identification of the user.

The technique of the present invention is not restricted to the unmanned contract processing system and the transaction system discussed above, but may also be applicable to an unmanned contract processing apparatus, a contract terminal, and an informationproviding medium for transferring identification information to the contract terminal, which are included in these systems. Another application of the present invention is a method of processing an unmanned contract, corresponding to the unmanned contract processing system. Other applications include a computer program that causes the computer to attain the respective functions of the unmanned contract processing system discussed above, and an information-providing storage medium in which the computer program is stored.

Typical examples of the information-providing storage medium include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates the construction of an unmanned contract processing system in one embodiment of the present invention;

FIG. 2 schematically illustrates the structure of a cellular phone included in the unmanned contract processing system shown in FIG. 1;

FIG. 3 shows functional blocks of a contract processing apparatus included in the unmanned contract processing system shown in FIG. 1;

FIG. 4 shows a processing flow of a contract;

FIG. 5 is a flowchart showing a pre-examination result inquiry routine;

FIG. 6 is a flowchart showing a processing routine executed by a contract terminal in actual contract process;

FIG. 7 is a flowchart showing a pre-examination result fetching routine;

FIG. 8 shows a method of authentication when a user has been subjected to preliminary examination;

FIG. 9 shows a processing flow of a contract executed in a second embodiment of the present invention; and

FIG. 10 shows a processing flow of a contract executed in a third embodiment of the present invention.

### DESCRIPTION OF THE PREFERRED EMBODIMENTS

Some modes of carrying out the present invention are discussed below in the following sequence as preferred embodiments:

A. Construction of System

B. Processing of Contract

B1. Phase 1 (Transmission of Preliminary Information)

B2. Phase 2 (Notification of Result of Pre-Examination)

B3. Phase 3 (Actual Contract Process)

C. Second Embodiment

D. Third Embodiment

E. Modifications

### A. Construction of System

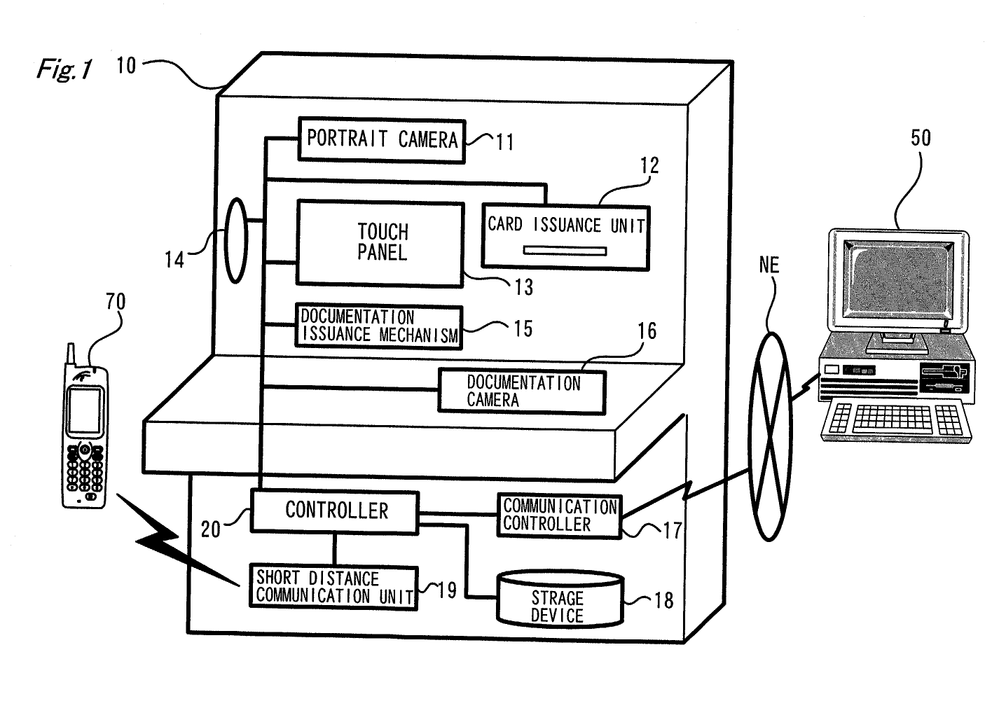

FIG. 1 illustrates the construction of an unmanned contract processing system in one embodiment of the present invention. This embodiment describes the system for conclusion of loan contracts between a financial institute and users. The loan contracts processed by this system include new loan applications and renewal of loans.

The unmanned contract processing system includes a contract terminal 10, a contract processing apparatus 50 that communicates with the contract terminal 10 via a network NE, and a cellular phone 70. The network NE may be constructed by any of various communication lines like a public communication line or an exclusive line. Each user carries out operations required for conclusion of a contract at the contract terminal 10. The contract processing apparatus 50 is manipulated by an operator of the personal finance company to obtain information required for the contract from the contract terminal 10 and the cellular phone 70 and execute a series of processing for conclusion of the contract. The contract processing apparatus 50 may be constructed as a combination of a device that transmits information to and from the contract terminal 10 with a host computer that transmits information to and from the cellular phone 70. In the description hereof, the contract processing apparatus 50 also represents such construction. The cellular phone 70 is owned by the user of this system and communicates with the contract terminal 10 and the contract processing apparatus 50 to be utilized as a PDA for the enhanced convenience of the user to make the contract. In the structure of the first embodiment, the cellular phone 70 functions as the information providing medium of the present invention. The cellular phone 70 may be replaced with any of diverse PDAs that are communicable with the contract terminal 10 and the contract processing apparatus 50.

The schematic structure of the contract terminal 10 is also illustrated in FIG. 1. The contract terminal 10 has a touch panel 13 and a speaker 14 to give operation guidance to the user. The touch panel 13 displays the procedure of operation and also functions as an input unit to receive the user's information required for the contract.

The user-related information is gained with a documentation camera 16 and a portrait camera 11, in addition to the user's information from the touch panel 13. The documentation camera 16 illuminates an ID card or paper like a driver's license and a contract document with a lamp and optically takes in their images. A scanner may be used instead of the camera. The portrait camera 11 takes a face image of the user. This image is utilized to check the authenticity of the photograph applied on the driver's license or another ID card or paper.

The user's information input from the touch panel 13, the document images shot with the documentation camera 16, and the portrait image shot with the portrait camera 11 are once stored in a storage device 18. These pieces of information are then transmitted to the contract processing apparatus 50 via a communication controller 17. The communication controller 17 also functions to receive instructions from the contract processing apparatus 50 via the network NE.

A short distance communication unit 19 communicates with the cellular phone 70 owned by the user, while the user operates the contract terminal 10. The communicable range is limited to a short distance about the contract terminal 10. This embodiment utilizes Bluetooth (trademark) and sets the communicable range to be approximately 1 m. The short distance communication is not restricted to Bluetooth but may utilize any of diverse feeble radio waves and infrared rays. Instead of the wireless communications, the cellular phone 70 may be connected to the contract terminal 10 via a cable or the like for wire communication.

A documentation issuance mechanism 15 and a card issuance unit 12 respectively issue a contract document and a contract card.

The operations of the contract terminal 10 are controlled by a controller 20, which is constructed as a microcomputer including a CPU, a RAM, and ROM and executes various series of processing required for the contract according to preset computer programs.

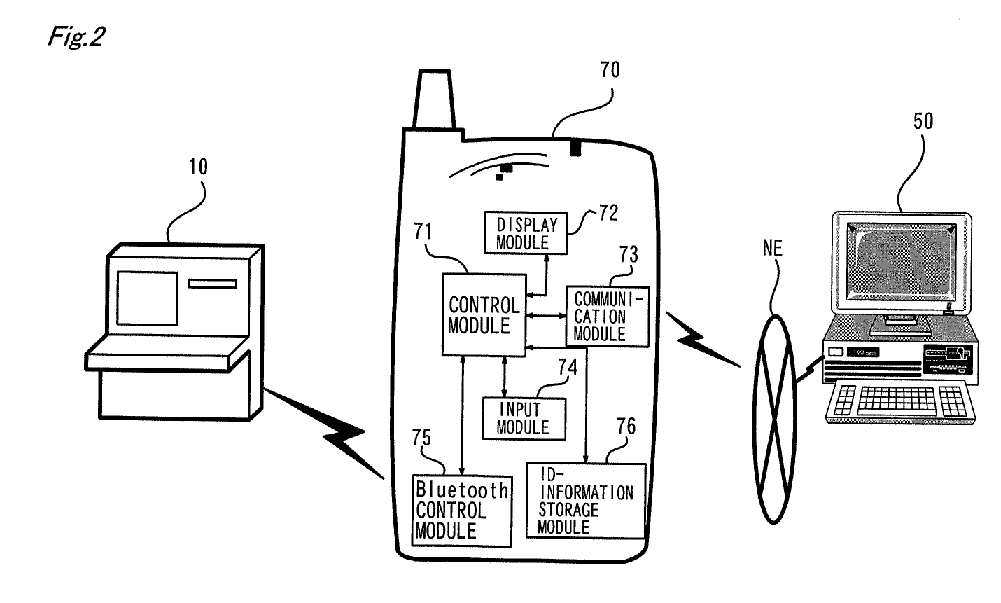

FIG. 2 schematically illustrates the structure of the cellular phone 70. As described later, the cellular phone 70 functions as a terminal for transmitting preliminary information required for the contract to the contract processing apparatus 50 (including the non-illustrated host computer) and as an information providing medium for transmitting identification information, which is used to identify the preliminary information, to the contract terminal 10. The cellular phone 70 accordingly exerts the functions required for communication with the contract processing apparatus 50 and the contract terminal 10.

The general operations of the cellular phone 70 are controlled by a control module 71. The control module 71 is a microcomputer including a CPU and a memory. A communication module 73 communicates with the contract processing apparatus 50 via a network like the Internet. An input module 74 receives required information for the contract, based on operations of buttons and other keys provided on the cellular phone 70. The input pieces of information are displayed on a liquid crystal display by means of a display module 72, while being transmitted to the contract processing apparatus 50 by means of a communication module 73. A Bluetooth control module 75 utilizes Bluetooth to communicate with the contract terminal 10. When the short distance communication unit 19 of the contract terminal 10 adopts any communication means other than Bluetooth, the Bluetooth communication module 75 should be replaced with a structure corresponding to the adopted communication means.

A identification information storage module 76 is a memory in which the identification information is stored. In this embodiment, address information for identifying the cellular phone 70 on the communication via the network, for example, an MAC address, is used as the identification information as discussed later. In this embodiment, the identification information storage module 76 is thus actualized by an IC chip in which the MAC address is stored. The identification information is used not only for the processing of the application for the contract but for the processing of communication by the communication module 73 and the Bluetooth control module 75. When any information unrelated to the address information is used as the identification information, the identification information storage module 76 may be constructed as a memory area on the RAM.

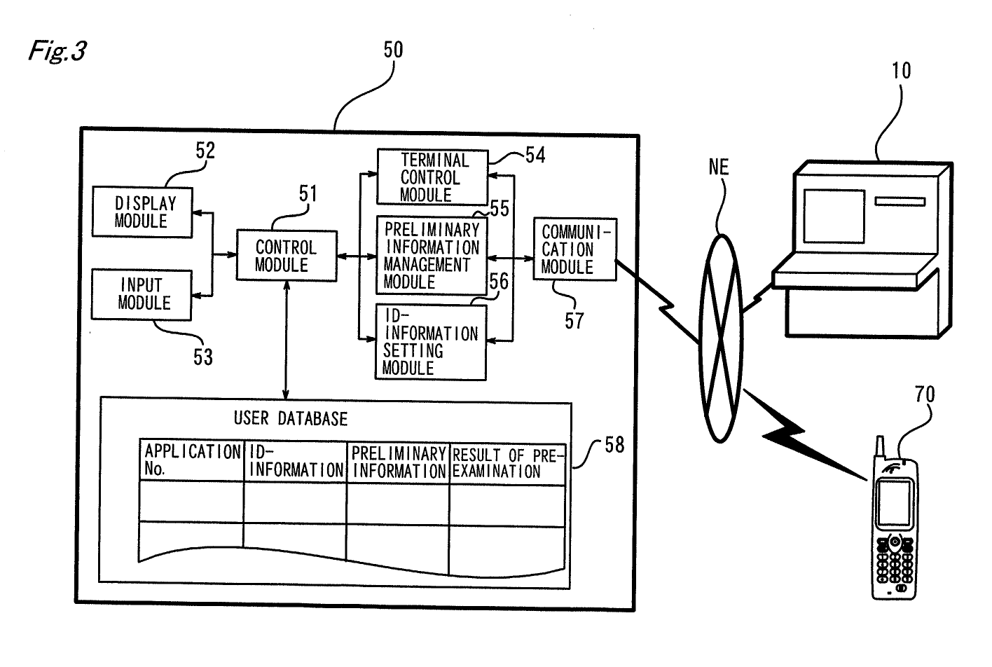

FIG. 3 shows functional blocks of the contract processing apparatus 50. The contract processing apparatus 50 is constructed by a general-purpose personal computer that has the function of communication via the network and is provided with the respective functional blocks attained by software. As mentioned previously, some of the functional blocks of the contract processing apparatus 50 may be included in a separate host computer.

A control module 51 represents a main program that controls the general operations of the contract processing apparatus 50. The other functional blocks work under the control of this control module 51. An input module 53 receives required information through operations of a keyboard and a mouse by the operator of the financial institute. A display module 52 displays information required for the operations on a monitor.

A communication module 57 controls communication via the network NE. A terminal control module 54 controls the operations of the contract terminal 10 in the course of the processing of the application for the contract via the communication module 57. A preliminary information management module 55 transmits part of the required information for the contract, as preliminary information, to and from the cellular phone 70 via the network NE. The input preliminary information is mapped to the identification information and is stored by the unit of each contract in a user database 58. The identification information is specified by a identification information setting module 56. In this embodiment, the MAC address of the cellular phone 70 is used as the identification information. The identification information setting module 56 accordingly fetches the MAC address through the communication of the contract processing apparatus 50 with the cellular phone 70 and registers the fetched MAC address as the identification information in the user database 58. In the case where the host computer is in charge of the communication with the cellular phone 70, the preliminary information may be stored in the host computer.

The identification information is not restricted to the MAC address. The function of the identification information setting module 56 is varied according to the contents of the adopted identification information. For example, when information specified by the contract processing apparatus, for example, an application number, is used for the identification information, the identification information setting module 56 functions to notify the cellular phone 70 of the identification information. In another example, when a number intrinsic to the user, for example, a bank account number, is used for the identification information, the identification information setting module 56 functions to input the identification information through the communication with the cellular phone 70.

The schematic configuration of the user database is also illustrated in FIG. 3. This user database stores the application number, the identification information, the preliminary information, and the result of preliminary examination with regard to each contract. The application number is a management number for each contract assigned by the contract processing apparatus 50. The preliminary information is received from the cellular phone 70, prior to the user's operations at the contract terminal 10, and represents basic information required for the contract, such as the name and the address of the user. The result of the preliminary examination specifies the acceptability of the contract, based on the preliminary information. The user database shown in FIG. 3 is only illustrative, but the user database may include more pieces of information.

### B. Processing of Contract

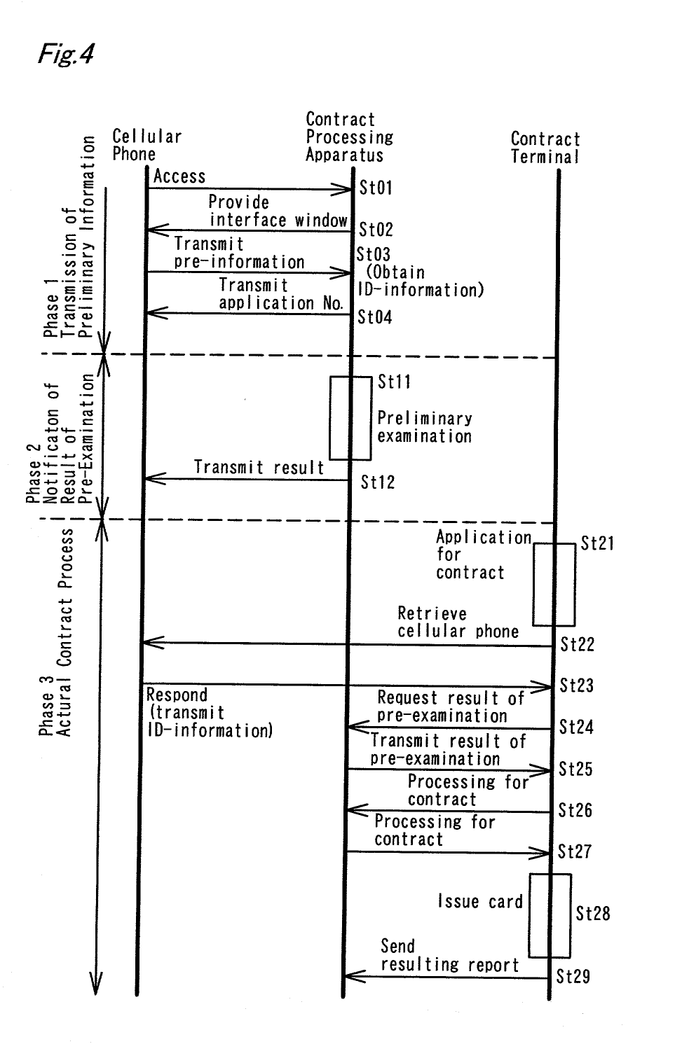

FIG. 4 shows a processing flow of a contract. This flow represents transmission of information between the cellular phone 70, the contract processing apparatus 50, and the contract terminal 10. In the system of this embodiment, the contract is processed in three phases, which are separate from one another on the time base. The processing of the contract discussed below is applicable to either of a new contract and a renewal of the existing contract.

### B1. Phase 1 (Transmission of Preliminary Information)

Phase 1 represents a series of processing related to transmission of preliminary information. This processing is implemented by operations of the cellular phone 70. When the user operates the cellular phone 70 and gains access to a Web site for contracts provided by a financial institute (step St01), the contract processing apparatus 50 opens an interface window for a contract (step St02). The user transmits preliminary information required for the contract according to the instructions of the interface window (step St03). In this embodiment, the following pieces of information are transmitted as the preliminary information: the name of the user, the birthday, the home address and the zip code, the home telephone number, the cellular phone number, the name of the working place, the telephone number of the working place, the annual income, selection between ‘home ownership’ and ‘rental dwelling’, and the house rent in the case of ‘rental dwelling’, and the total amount of loans from other financial institutes. These data may be transmitted separately after entry of each item or collectively after entry of all the required items.

When the transmission of all the required pieces of information has been completed, the contract processing apparatus 50 transmits the application number to the cellular phone 70 (step St04) and concludes the processing of Phase 1. The contract processing apparatus 50 registers the acquired information in the user database 58. The contract processing apparatus 50 fetches the address information intrinsic to the cellular phone 70, for example, the MAC address, and stores the intrinsic address information as the identification information in the course of the processing of Phase 1.

### B2. Phase 2 (Notification of Result of Pre-Examination)

Phase 2 represents a series of processing related to notification of the result of preliminary examination, that is, notification of the acceptability of the contract based on the preliminary information. The financial institute performs a preliminary examination to determine acceptability of the contract by the user, based on the information received in Phase 1 (step St11). On completion of the preliminary examination, the acceptability of the contract is transmitted with the application number assigned to the contract to the cellular phone 70 (step St12). The result of the preliminary examination is transmitted in the form of an E-mail via the network in this embodiment, although the result may be transmitted by telephone, facsimile, or another appropriate means.

Loan-related information, such as loan limit, may be transmitted together with the acceptability of the contract. Notification of the positive result of the preliminary examination represents the ready state for the contract. Information asking the user to carry out the operations at the contract terminal 10 and information relating to the location of the nearby contract terminal 10 may be transmitted together with such notification.

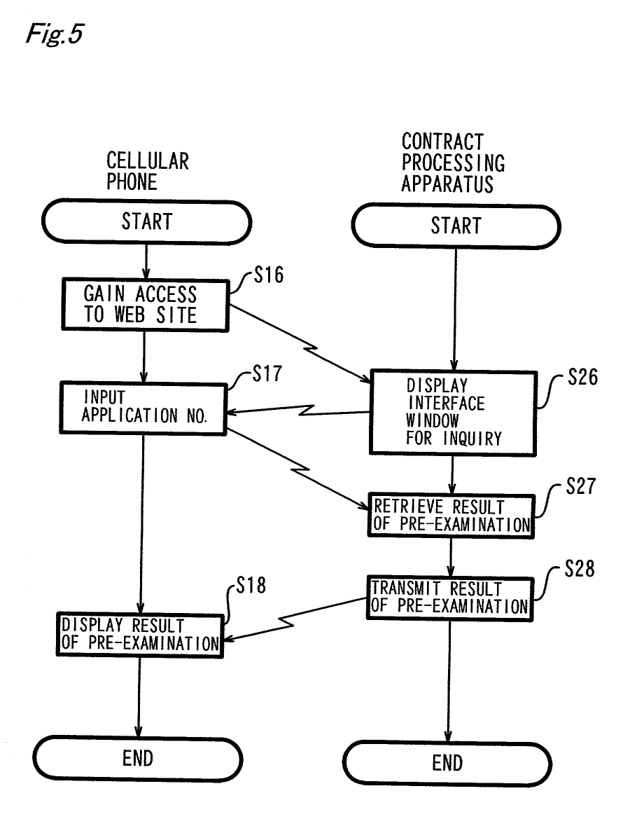

In the structure of this embodiment, the contract processing apparatus 50 notifies the user of the result of the preliminary examination. Direct inquiry of the user to the financial institute may be allowed, in place of the notification or in addition to the notification. FIG. 5 is a flowchart showing a pre-examination result inquiry routine. For the inquiry, the user operates the cellular phone 70 and gains access to the Web site provided by the financial institute (step S16). The contract processing apparatus 50 gives the cellular phone 70 an interface window for the inquiry in response to the access (step S26). When the user inputs the application number assigned to the contract (step S17), the contract processing apparatus 50 retrieves the user database 58 to find the result of the preliminary examination corresponding to the input application number (step S27) and transmits the result of the preliminary examination to the cellular phone 70 (step S28). The transmitted result of the preliminary examination is displayed on the cellular phone 70 (step S18). The display representing the result of the preliminary examination is varied according to the timing of inquiry. The display shows the acceptability of the contract when the result of the preliminary examination has already been registered in the user database 58. Otherwise the display shows information that the preliminary examination has not yet been concluded.

The procedure of this embodiment uses the application number for the inquiry of the result of the preliminary examination, but the identification information may be used for the same purpose. Using the application number that does not depend upon the cellular phone 70 advantageously enables the user to check the result of the preliminary examination with a terminal other than the cellular phone 70 used for transmission of the preliminary information.

The procedure of this embodiment requires input of the application number after the access to the Web page. Alternatively the procedure may specify a URL including information corresponding to the application number as a parameter in Phase 1. At the time of inquiry, the user simply gains access to the specified URL and readily checks the result of the preliminary examination without being required to input the application number.

### B3. Phase 3 (Actual Contract Process)

After receiving the result of the preliminary examination, the user goes to a branch shop of the financial institute where the contract terminal 10 is located and carries out an actual contract process. Referring back to FIG. 4, the outline of the actual contract process is described. For convenience of explanation, here it is assumed that the result of the preliminary examination represents that ‘the contract is acceptable’.

The user goes to a branch shop of the financial institute where the contract terminal 10 is located, and carries out an operation for the contract according to the instructions on the display of the window (step St21). In response to the user's operation, the contract terminal 10 communicates with the cellular phone 70 by means of Bluetooth and fetches the identification information from the cellular phone 70 (steps St22 and St23). In this embodiment, the address information of the cellular phone 70 is utilized as the identification information, so that acquisition of the identification information is completed when communication of the contract terminal 10 with the cellular phone 70 is established. In another applicable arrangement, the contract terminal 10 may continuously monitor the approach of any terminal having the Bluetooth function and automatically fetch the identification information in response to detection of the cellular phone 70 having such function.

The contract terminal 10 receives the result of the preliminary examination from the contract processing apparatus 50 according to the identification information thus obtained (steps St24 and St25). The contract terminal 10 then carries out authentication and other required processing for the contract, based on the result of the preliminary examination (steps St26 and St27). On completion of all the processing, the contract terminal 10 issues a card used for loans (step S28) and sends a resulting report to the contract processing apparatus 50 (step St29). This completes the processing of Phase 3.

The system of this embodiment may process the application for the contract, regardless of execution or non-execution of the preliminary examination. The details of the processing executed by the contract terminal 10 in the actual contract process are discussed below.

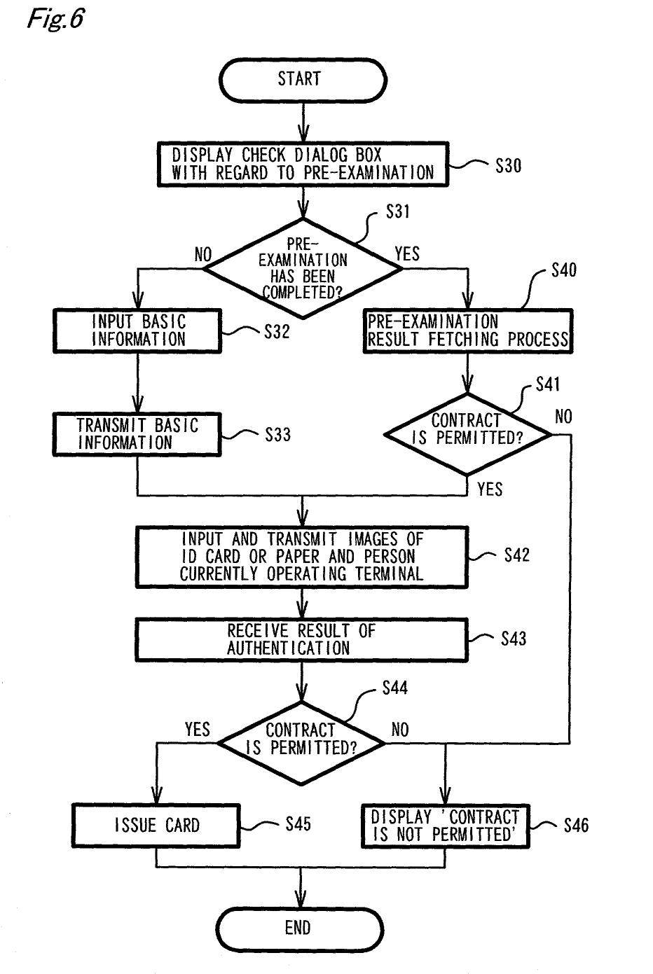

FIG. 6 is a flowchart showing the details of the processing executed by the contract terminal 10 in the actual contract process. When the program enters this processing routine, the contract terminal 10 displays a check dialog box with regard to execution or non-execution of the preliminary examination on the touch panel 13 (step S30). The check dialog box includes a selection menu, which allows the user to determine whether the preliminary examination using the cellular phone 70 has been carried out or not. In the case where the user has been notified of the result of the preliminary examination, the user selects one option ‘Pre-examined’. Otherwise the user selects the other option ‘Not Pre-examined’.

In the case of selection of the option ‘Not Pre-examined’ (step S31), the contract terminal 10 shifts to a regular contract process. This process receives input of basic information required for the contract and transmits the input basic information to the contract processing apparatus 50 (steps S32 and S33). The basic information is equivalent to the preliminary information input via the cellular phone 70.

In the case of selection of the option ‘Pre-examined’ (step S31), on the other hand, the contract terminal 10 carries out a pre-examination result fetching process for effective use of the result (step S40). This process gains access to the contract processing apparatus 50 and fetches the result of the preliminary examination, based on the identification information kept in the cellular phone 70.

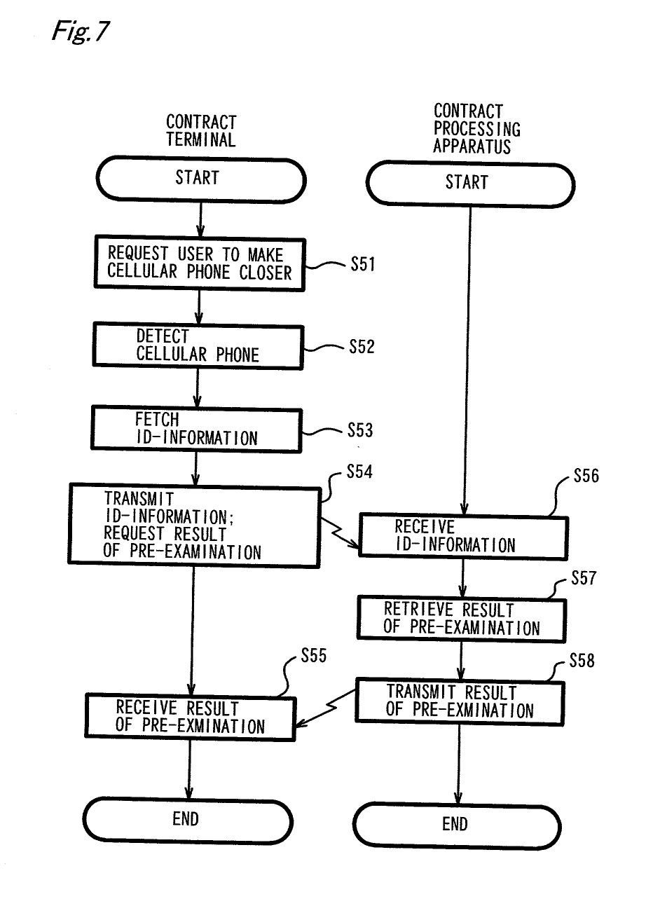

FIG. 7 is a flowchart showing the details of the pre-examination result fetching process. The contract terminal 10 gives a display on the touch panel 13 and requests the user to make the cellular phone 70 closer to the contract terminal 10 (step S51). In this embodiment, the contract terminal 10 communicates with the cellular phone 70 by means of Bluetooth. It is accordingly required that the contract terminal 10 and the cellular phone 70 are located sufficiently closer to each other to be in a communicable range.

When the user makes the cellular phone 70 closer to the contract terminal 10, the contract terminal 10 detects the presence of the cellular phone 10 (step S52) and fetches the identification information from the cellular phone 70 (step S53) according to the protocol of Bluetooth. In this embodiment, the MAC address of the cellular phone 70 is used as the identification information, so that acquisition of the identification information is implemented on establishment of the communication between the cellular phone 70 and the contract terminal 10. The contract terminal 10 transmits the identification information fetched in this manner to the contract processing apparatus 50 and requests the result of the preliminary examination (step S54). In order to prevent illegal contracts with unauthorized or found cellular phones 70, the contract terminal 10 may require the user to input a password or something equivalent in the process of fetching the identification information.

The contract processing apparatus 50 receives the identification information (step S56), retrieves the user database 58 to find the corresponding result of the preliminary examination (step S57), and transfers the result of the preliminary examination to the contract terminal 10 (steps S58 and S55). When the preliminary examination has been completed, the contract processing apparatus 50 transfers information representing permission or prohibition of the contract. When the preliminary examination has not yet been completed, on the other hand, the contract processing apparatus 50 transfers information showing that the preliminary examination has been uncompleted. In the case where the host computer functions to acquire the preliminary information, the contract processing apparatus 50 may obtain the result of the preliminary examination from the host computer.

Referring back to the actual contract process shown in the flowchart of FIG. 6, the contract terminal 10 continues the processing only in the case where the result of the preliminary examination is ‘Contract is Permitted’ (step S41). Otherwise the contract terminal 10 gives a display representing ‘Contract is Not Permitted’ on the touch panel 13 (step S46) and exits from the actual contract process of FIG. 6.

When the result of the preliminary examination is ‘Contract is Permitted’ (step S41) or when the user has not been subjected to the preliminary examination, the program proceeds to a process for authentication. The contract terminal 10 inputs the image of the ID card or paper and the image of the person who actually operating the contract terminal 10, and transmits the input images with the identification information or the application number to the contract processing apparatus (step S42). The ID card or paper may be a driver’s license or a passport. The image of the ID card or paper is taken with the documentation camera 16. The image of the person is taken with the portrait camera 11. The operator of the financial institute operates the contract processing apparatus 50 and carries out authentication based on these images.

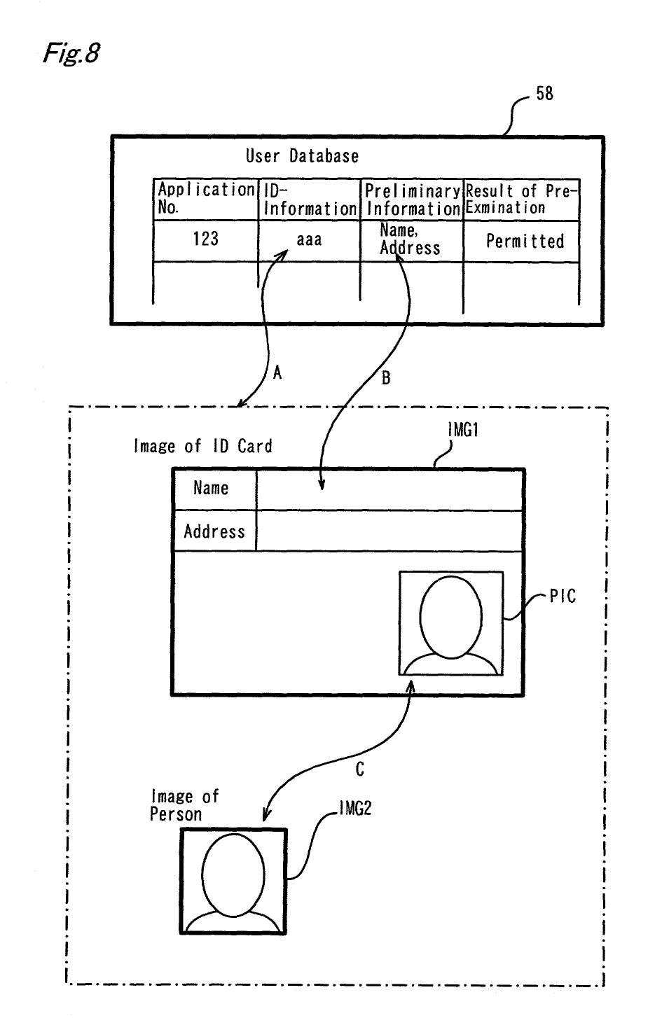

FIG. 8 shows a method of authentication when the user has been subjected to the preliminary examination. In this case, it is required to determine whether or not the person currently operating the contract terminal 10 is identical with the photograph applied on the ID card or paper and whether or not the preliminary information transmitted from the cellular phone 70 is consistent with the contents of the ID card or paper. The former identification is checked by comparison between a photograph PIC included in an image IMG1 of the ID card or paper and an image IMG2 of the person (see an arrow C).

The latter consistency is checked by comparison between the preliminary information registered in the user database 58 and the information included in the image IMG1 of the ID card or paper. In the process of transmission of the image IMG1 of the ID card or paper, the contract processing apparatus 50 specifies the preliminary information corresponding to the person currently operating the contract terminal 10, based on the identification information fetched from the cellular phone 70 (see an arrow A). The image IMG1 of the ID card or paper includes information partly overlapping the information registered in the user database 58, such as the name and the address of the person. The consistency of the information is checked in the overlapped range for authentication of the preliminary information (see an arrow B). This arrangement effectively reduces the possibility of unfair contracts based on false information and illegal contracts with the unauthorized or found cellular phone 70. In the example of FIG. 8, the preliminary information is authenticated based on the name and the address of the person. The information used for the authentication is, however, not restricted to such data.

Referring back again to the actual control process in the flowchart of FIG. 6, the contract terminal 10 receives the result of the authentication from the contract processing apparatus 50 (step S43). The result of the authentication includes the final decision with regard to permission or prohibition of the contract by the operator of the financial institute.

In the case of input of the final decision ‘Contract is Permitted’ (step S44), the contract terminal 10 issues a card used for loans (step S45) and exits from this actual contract process routine. In the case of input of the final decision ‘Contract is Not Permitted’ (step S44), on the other hand, the contract terminal 10 gives a display representing ‘Contract is Not permitted’ on the touch panel 13 (step S46) and exits from this actual contract process routine.

The contract processing system of the first embodiment discussed above enables the identification information to be transmitted to the contract terminal 10 and to the contract processing apparatus 50 via the cellular phone 70 as the information-providing medium without requiring the user to write down the identification information. The arrangement allows the result of the preliminary examination based on the preliminary information to be readily and certainly utilized for conclusion of the contract. This desirably shortens the user's opening time at the contract terminal 10 and the waiting time to completion of the examination, thus enhancing the convenience of the unmanned contract processing system and the capacity operating rate of the contract terminal 10.

The contract processing system of this embodiment notifies the user of the result of the preliminary examination. This arrangement enables the user to actually go to a branch shop of the financial institute after receiving the result of the pre-examination showing that ‘the contract is acceptable’, thus effectively enhancing the convenience of the user to make the contract.

### C. Second Embodiment

In the structure of the first embodiment, the address information intrinsic to the cellular phone 70 is used as the identification information. In the structure of a second embodiment, information that does not depend upon the cellular phone 70 is used as the identification information.

The system construction of the second embodiment is substantially similar to that of the first embodiment shown in FIGS. 1 through 3. In the following description, a general purpose computer connectable with the network is used for transmission of the preliminary information. The preliminary information may otherwise be transmitted with the cellular phone 70 or by facsimile or by post. Whereas the identification information storage module 76 included in the cellular phone 70 stores the address information in the first embodiment, the structure of the second embodiment stores information that does not depend upon the terminal like the cellular phone 70.

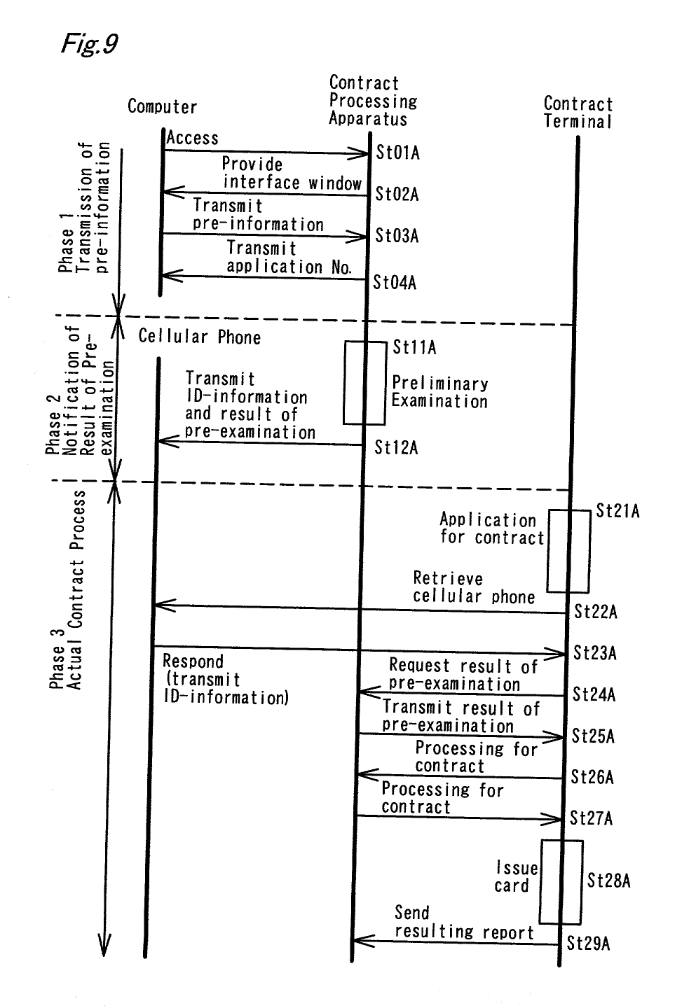

FIG. 9 shows a processing flow of a contract executed in the second embodiment. The processing flow of the second embodiment includes three phases, like the processing flow of the first embodiment shown in FIG. 4. In Phase 1, the user transmits the preliminary information and receives the application number with a computer connectable with the network (steps St01A through St04A). Unlike the first embodiment, the contract processing apparatus 50 is not required to fetch the address information of the computer as the identification information in this process. In the construction of the second embodiment, the preliminary information includes a mail address of a terminal, which may be different from the computer, as the destination of notification representing the result of the preliminary examination. This piece of information may be omitted when the same terminal is used for the operation of Phase 1 and the notification.

In Phase 2, the contract processing apparatus 50 sends the result of the preliminary examination to the mail address specified in Phase 1 (steps St11A and St12A). In the example of FIG. 9, the cellular phone 70 of the user is specified as the destination of notification. The notification is given in the form of an E mail and includes the result of the preliminary examination and the identification information. The identification information is arbitrarily settable by the contract processing apparatus 50. The identification information may be the application number or any different piece of information.

Phase 3 carries out a similar series of processing to that of the first embodiment (steps St21A through St29A), although the contract terminal 10 in the second embodiment fetches the identification information from the cellular phone 70 according to a different procedure from that of the first embodiment. In the construction of the second embodiment, the identification information is included in the notification transmitted in the form of the E mail. The contract terminal 10 thus gains access to a hardware resource of the cellular phone 70 and detects the identification information after establishment of communication with the cellular phone 70.

A variety of methods may be applicable for the detection. A first applicable method causes the contract terminal 10 to retrieve the E mail transmitted from the contract processing apparatus 50 to the cellular phone 70 and analyze the contents of the E mail, thereby obtaining the identification information. This process is actualized by transmitting a program for attaining such functions from the contract terminal 10 to the cellular phone 70. In one possible modification, the contract terminal 10 once reads all E mails kept in the cellular phone 70 and retrieves the corresponding E mail.

A second applicable method causes the identification information to be included in a title of the E mail as the notification of the result of the preliminary examination. This method ensures acquisition of the identification information only through retrieval of the title and does not require analysis of the contents of the E mail. This process is actualized by transmitting a program for attaining such functions from the contract terminal 10 to the cellular phone 70.

A third applicable method causes the user to transfer the E mail as the notification of the result of the preliminary examination to the contract terminal 10. The acquisition of the identification information is not restricted to these methods, but any adequate procedure may be specified according to the technique of communication of the contract terminal 10 with the cellular phone 70 and the processing power of the cellular phone 70.

The communication of the contract terminal 10 with the cellular phone 70 is not necessary for the acquisition of the identification information. In one possible modification, the identification information is displayed on the cellular phone 70 through the user's operations and read with the documentation camera 16 of the contract terminal 10. In such cases, it is preferable that the identification information is displayed as coded data like a barcode, in order to prevent forgery and falsification and ensure the sufficient reading accuracy.

The processing after acquisition of the identification information is identical with that of the first embodiment. The contract terminal 10 obtains the result of the preliminary examination based on the identification information and carries out the processing for the contract.

Like the first embodiment, the system of the second embodiment effectively utilizes the preliminary information and efficiently carries out the processing for the contract. The arrangement of the second embodiment also ensures easy specification of the preliminary examination and enhances the convenience of the system.

The system of the second embodiment allows different terminals to be used for the transmission of the preliminary information and the notification of the result of the preliminary examination. For example, a general purpose computer having the high operatability is used for transmission of the preliminary information, whereas the notification is received by a portable terminal like the cellular phone 70. This arrangement enhances the convenience of the system.

### D. Third Embodiment

In the first embodiment and the second embodiment discussed above, the identification information is acquired through communication of the contract terminal with the cellular phone 70. The information-providing medium for transferring the identification information to the contract terminal 10 is not restricted to media having the function of communication. In a third embodiment of the present invention, a magnetic card or more specifically an ATM card is used as an information-providing medium without the function of communication

The construction of the contract processing apparatus 50 in the third embodiment is substantially the same as that of the first embodiment. The contract terminal 10 of the third embodiment has some difference from that of the first embodiment. In the third embodiment, the short distance communication unit 19 may be omitted, since the contract terminal 10 is not required to establish communication by means of Bluetooth in the actual contract process. The card issuance unit 12 has an additional function of reading information from the magnetic card.

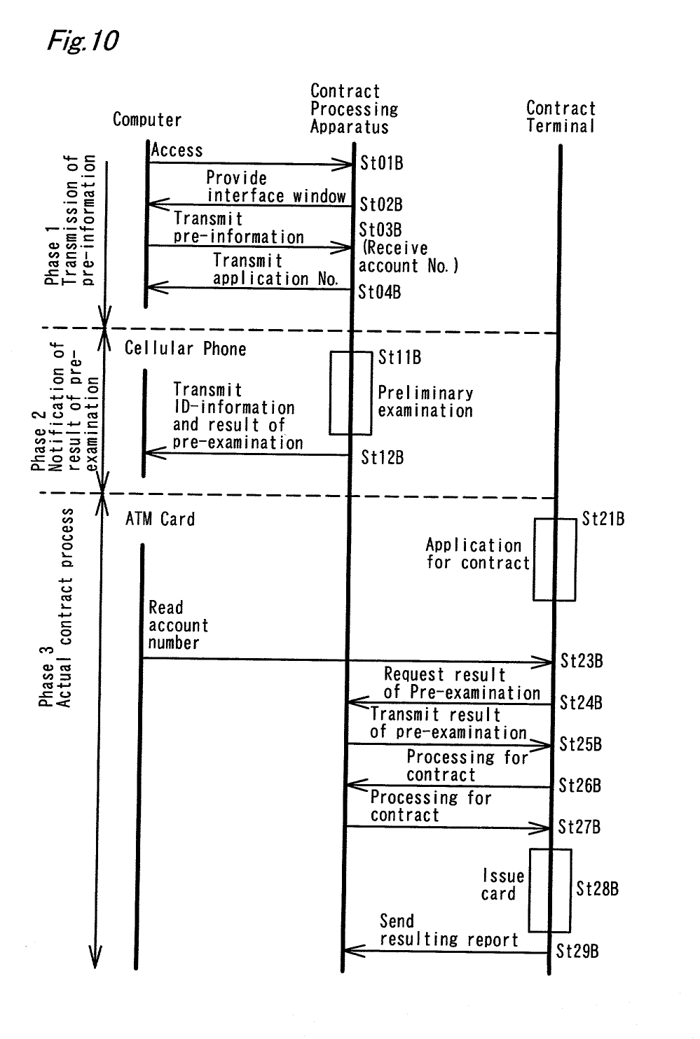

FIG. 10 shows a processing flow of a contract executed in the third embodiment. The processing flow of the third embodiment also includes three phases. Like the second embodiment, the user transmits the preliminary information with a computer connectable with the network in Phase 1 (steps St01B through St04B). In the third embodiment, information recorded on the ATM card, for example, an account number, is used as the identification information. The user transmits the account number corresponding to the ATM card together with the preliminary information including the name and the address of the user to the contract processing apparatus 50 (step St03B). The contract processing apparatus 50 stores the transmitted account number as the identification information into the user database 58. The processing of Phase 1 may be carried out with a cellular phone connectable with the network, instead of the computer.

The notification of the result of the preliminary examination in Phase 2 follows the procedure of the first embodiment and the second embodiment. The contract processing apparatus 50 transmits the result of the preliminary examination based on the preliminary information to the cellular phone 70 of the user in the form of an E mail (steps St11B and St12B).

In the actual contract process of Phase 3, the ATM card is used as the information-providing medium for transferring the identification information to the contract terminal 10. The user operates the contract terminal 10 for the contract (step St21B) and inserts the ATM card into the slot of the card issuance unit 12. The contract terminal 10 reads the account number as the identification information from the ATM card (step ST23B). The processing after acquisition of the identification information is identical with those of the first embodiment and the second embodiment (steps St24B through St29b).

The system of the third embodiment does not utilize the communication for acquisition of the identification information and thus ensures stable acquisition of the identification information without being affected by the communication environment, such as instability of communication.

In the third embodiment, the ATM card is used as the information-providing medium for transferring the identification information. A variety of other magnetic cards with record of certain information like a credit card and other appropriate media may be used for the same purpose.

### E. Modifications

In the embodiments discussed above, the preliminary information is transmitted via the network. Transmission of the preliminary information may alternatively be implemented by facsimile or by post. For example, in the first embodiment and the second embodiments, the transmission of the identification information between the contract processing apparatus 50 and the cellular phone 70 may be carried out when the user is notified of the result of the preliminary examination. This arrangement then allows the identification information to be transferred from the cellular phone 70 to the contract terminal 10.

In the embodiments discussed above, the contract processing apparatus 50 notifies the user of the result of the preliminary examination in Phase 2. Such notification may be omitted if not required. As long as the transmission of the identification information between the contract processing apparatus 50 and the information-providing medium is completed in the process of transmission of the preliminary information in Phase 1, the identification information can be transferred from the information-providing medium to the contract terminal 10 without the processing of Phase 2.

The embodiments regard the processing of the contract for a loan. Actual withdrawal of loan money may immediately follow conclusion of the contract.

In the system of any of the above embodiments, the photograph of the user taken with a digital camera or another camera may be included in the preliminary information in Phase 1. Request of transmission of the user's photograph effectively reduces ridiculous or meaningless contracts.

A menu option for the contract may be displayed on the contract terminal only in the case of selection of ‘Pre-Examined’. Such modification effectively reduces intentional or unintentional selection of the menu option for the contract by the user who has not been subjected to the preliminary examination, thus enhancing the capacity operating rate of the contract terminal. This arrangement is especially useful for the unmanned contract processing system constructed as a complex machine having a large number of menu options other than the menu option for the contract. One example of the complex machine is combination of an automatic teller machine and an automatic loan application machine.

The above embodiments regard applications for loan contracts in financial institutes. The system of the present invention is applicable to process a diversity of contracts, such as applications for purchase of items and various services. One example is a train seat reservation system. In the seat reservation system, the user reserves a seat of a certain train with the cellular phone in Phase 1, and a railroad company transmits a reservation number to the user's cellular phone. In the processing of Phase 3, a ticket vending machine having the function of Bluetooth communication fetches the reservation number from the user's cellular phone and issues a ticket for the reserved seat. In the processing of Phase 2, a notice representing successful reservation of the seat may be given to the user's cellular phone. The system of the present invention is applicable for processing of such contracts.

The above embodiments and their modifications are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein. For example, the series of control processes discussed above may be attained by the hardware construction, instead of the software configuration. In the embodiments discussed above, the contract processing apparatus 50 is actualized by a single computer. The contract processing apparatus 50 may alternatively be attained by multiple hardware devices including a host computer for distributive processing.

The system of the present invention enables the user to transfer the identification information, which is used to identify preliminary information transmitted in advance, to the contract terminal via some information-providing medium. The preliminary information transmitted in advance to the contract processing apparatus can thus be utilized without any user's burden to write down the identification information. This arrangement thus ensures quick processing of an application for a contract.

The contract processing apparatus notifies the user of the result of preliminary examination, based on the preliminary information. The user carries out a series of processing required for conclusion of the contract only when the notification proves that the application for the contract is acceptable. This arrangement desirably avoids waste of time and labor.

The scope and spirit of the present invention are indicated by the appended claims, rather than by the foregoing description.

What is claimed is:

1. An unmanned contract processing system that automatically processes an application for a contract, said unmanned contract processing system comprising:
a contract processing apparatus configured to processes the applicationcontract; and
a contract terminal that is connected with said contract processing apparatus via a communication line and is manipulated by a usercontract to implement an operation required for the applicationcontract,
said contract processing apparatus comprising:
a preliminary information input module that receives from the user at least part of information required for the contract as preliminary information, prior to the operation at said contract terminal; and
a preliminary information storage module that stores a mapping to map the preliminary information to identification information,
said contract terminal comprising:
an identification information input module that receives the identification information from an information-providing medium, in which the identification information is stored; and
a contract execution module that transmits the identification information to said contract processing apparatus and receives required information to execute processing of the applicationcontract.

2. A contract terminal that is connected with a contract processing apparatus, which processes an application for a contract, via a communication line and is manipulated by a usercontract to implement an operation required for the application for the contract, said contract terminal comprising:
an identification information input module that receives identification information from an information-providing medium, in which the identification information is stored, the identification information being used to identify preliminary information that has been transmitted in advance to said contract processing apparatus; and
a contract execution module that transmits the identification information to said contract processing apparatus and receives required information to execute processing of the applicationcontract.

3. A contract terminal in accordance with claim 2, wherein said identification information fetching module fetches the identification information through short-distance communication with said information-providing medium.

4. A contract terminal in accordance with claim 3, wherein the short-distance communication is Bluetooth.

5. A contract terminal in accordance with claim 2, wherein the processing of the application for the contract executed by said contract execution module includes a process of receiving authentication information for authenticating the user, and
the authentication information at least partly overlaps the preliminary information.

6. A contract processing apparatus that is connected with a contract terminal, which is manipulated by a usercontract to implement an operation required for an application for the contract, via a communication line and processes the applicationcontract based on information obtained via said contract terminal, said contract processing apparatus comprising:
a preliminary information input module that receives preliminary information required for the processing of the application for the contract, prior to the user's operation for the applicationcontract;
a preliminary information storage module that stores a mapping to map the preliminary information to identification information;
a identification information fetching module that fetches the identification information via said contract terminal from a information-providing medium, in which the identification information is stored; and
a contract processing control module that causes said contract terminal to execute the processing of the application for the contract, based on the fetched identification information.

7. A contract processing apparatus in accordance with claim 6, wherein said information-providing medium has a function of communicating with said contract processing apparatus,
said contract processing apparatus further comprising:
a identification information notification module that notifies said information-providing medium of the identification information.

8. A contract processing apparatus in accordance with claim 7, wherein said preliminary information storage module is allowed to notify a certain address, which is different from an input source of the preliminary information, of the preliminary information.

9. A contract processing apparatus in accordance with claim 6, said contract processing apparatus further comprising:
a ready state notification module that notifies the user of a ready state for the contract, based on the preliminary information.

10. A contract processing apparatus in accordance with claim 6, wherein the identification information is intrinsic to said information-providing medium and is utilized for communication of said contract terminal with said information-providing medium.

11. An information-providing medium that communicates with a contract processing apparatus that processes an application for a contract and supplies part of information required for the contract to a contract terminal manipulated by a usercontract, said information-providing medium comprising:
an identification information storage module that stores identification information for identifying preliminary information, which has been transmitted in advance to said contract processing apparatus by the user; and
a communication module that communicates with said contract terminal to transmit the identification information to said contract terminal in response to a requirement from said contract terminal.

12. An information-providing medium in accordance with claim 11, said information-providing medium further comprising:
a preliminary information transmission module that transmits the preliminary information to said contract processing apparatus.

13. An information-providing medium in accordance with claim 11, said information-providing medium further comprising:
an identification information receiving module that receives the identification information from said contract processing apparatus and causes the input identification information to be stored in said identification information storage module.

14. An information-providing medium in accordance with claim 11, said information-providing medium further comprising:
a ready state notification receiving module that receives from said contract processing apparatus a notification representing a ready state for the contract based on the preliminary information.

15. An unmanned contract processing method that automatically processes an application for a contract using a contract processing apparatus and a contract terminal, which communicate with each other via a communication line,
said unmanned contract processing method comprising:
a preliminary step executed by said contract processing apparatus; and
an actual contract step executed by said contract terminal,
said preliminary step comprising the steps of:
receiving at least part of information required for the contract as preliminary information, prior to a user's operation at said contract terminal; and
mapping the preliminary information to identification information and storing the mapping,
said actual contract step comprising the steps of:
receiving the identification information from an informationproviding medium, in which the identification information is stored; and
transmitting the identification information to said contract processing apparatus and receiving required information to execute processing of the application for the contract.

16. A settlement terminal that is used for a transaction process with regard to at least one of an application for purchase of an item and an application for a contract, said settlement terminal comprising:
a transaction process control module that receives identification information from a first apparatus held by a user, and executes the transaction process based on the identification information,
wherein the identification information is transmitted from a second apparatus, which is involved in the transaction process and is communicable with said settlement terminal and said first apparatus, to said first apparatus, in response to transmission of at least part of information required for the transaction process from said first apparatus to said second apparatus prior to the transaction process.

17. A settlement terminal in accordance with claim 16, said settlement terminal further comprising:
a menu display unit that displays a menu option to allow the user to select a certain transaction when it is confirmed that the certain transaction using the identification information is acceptable.

18. A transaction system that executes a transaction process with regard to at least one of an application for purchase of an item and an application for a contract, said transaction system comprising:
a settlement terminal;
a first apparatus manipulated by a user; and
a second apparatus that is involved in the transaction process, is communicable with said settlement terminal and said first apparatus, and receives from said first terminal at least part of information required for the transaction process,
wherein said second apparatus transmits, in response to the input of the at least part of the required information, identification information for identifying the input information, and
said settlement terminal communicates with said first apparatus to receive the identification information and execute the transaction process.

19. A transaction system in accordance with claim 18, wherein the information transmitted from said first apparatus to said second apparatus includes information representing a physical characteristic for identification of the user.
